(19) United States
(12) Patent Application Publication
(10) Pub. No.: US 2023/0027776 A1
(43) Pub. Date: Jan. 26, 2023

(54) Modular LIDAR Altimeter for Aircraft

(71) Applicant: Sean Sherman, Nashville, TN (US)

(72) Inventor: Sean Sherman, Nashville, TN (US)

(21) Appl. No.: 17/385,184

(22) Filed: Jul. 26, 2021

(51) Int. Cl. G01S 17/10; G08G 5/02; B64D 45/08; G01S 17/933

(52) U.S. Cl. CPC G01S 17/10; G08G 5/025; B64D 45/08; G01S 17/933

(57) ABSTRACT

This invention involves a modular LIDAR altimeter for aircraft to aid in navigation. Principally, this invention gathers altimetric readings that are more highly accurate than traditional data typically available to the average pilot. The modular LIDAR altimeter is designed to be easily attached to and detached from the outside of the aircraft, resulting in no modifications to the aircraft itself. The invention uses a LIDAR to perform ranging measurements enclosed in a container consisting of all the components necessary for its operation. Data from the modular LIDAR altimeter is wirelessly transmitted to be interpreted by a separate device.

### FIELD OF INVENTION

The invention described herein pertains generally to the field of aircraft altimeters. Specifically, the invention describes aircraft altimeters using a laser ranging measurement device, colloquially known as a LIDAR (light detecting and ranging), to determine the aircrafts' altitude above the ground. The invention describes this device to be modular, meaning that installing and removing the device from the aircraft requires a minimum of tools, and requires no modification to the aircraft itself.

### BACKGROUND OF THE INVENTION

Small general aviation aircraft typically have two types of altimeters available to them: GPS and barometric. The barometric altimeter uses the difference in pressure at altitude to determine an aircrafts' altitude above mean sea level (MSL). The GPS can give an approximate aircraft altitude above ground level (AGL). However, both barometric and GPS altimeters have an inherent error to them and can be off by upwards of fifty feet. Large aircraft get around this issue by using their radar as altimeters. This method of determining an aircrafts' altitude AGL is very accurate, capable in some instances of giving measurements with sub-inch accuracy. Unfortunately, small aircraft cannot typically use radar altimeters as these radars are fairly large in terms of weight and volume when the small aircraft has limited amounts of weight and volume to sacrifice. This tends to leave small general aviation aircraft with no accurate way of determining AGL, causing hard landings and accidents when flying conditions become less than optimal.

LIDAR units can bridge the gap between the light weight of barometric/GPS altimeters and the accuracy of radars. Typically weighing less than one pound, LIDARs can give accurate ranges from hundreds of feet away. Because of this capability, LIDARs have become very popular accessories on unmanned aerial vehicles (UAVs). LIDARs function by emitting a laser signal and measuring the time it takes for the return signal to arrive. This time of flight is then used to calculate the distance between the LIDAR and the object that reflected the signal.

Typically, LIDAR units are not modular by nature. Modular in this sense meaning that the unit can be attached and removed from a host object with relative ease. The various electronics that LIDARs rely upon tend to be numerous, complicated, and delicate. As a result, LIDARs are typically somewhat permanently attached to the host object, especially via electrical connections and structural members.

U.S. Pat. No. 9,091,538 by Zhang attempts to resolve some of these problems by mounting a laser altimeter to the fuselage of a small aircraft. While undoubtedly effective, one skilled in the arts will recognize that mounting the device to the aircraft will result in modifications to the structure of the aircraft. These modifications typically require clearance by the local/national aviation authority and for the work to be done by a licensed airframe and powerplant mechanic (or engineer), which can result in costs of thousands of dollars. Further, this would result in a semi-permanent placement of the device, leaving it exposed to the elements for months at a time, as well as increasing the likelihood of theft.

U.S. patent Ser. No. 10/269,256 by Youngquist describes a similar solution as the previously mentioned Zhang patent. Youngquist envisioned the laser altimeter mounted on the interior of an aircraft window, with a reflector mounted to the opposite side of the window to direct a laser beam downwards. While somewhat modular and not altering the structure of the aircraft, the nature of this device being mounted on the interior of a window means that the laser may not always have a direct line of site to the ground as is necessary for operation, specifically if the aircraft uses large tires, floats for water operation, or is a low-wing aircraft.

U.S. patent Ser. No. 10/457,416 by Nikitenko envisions a modular AGL altimeter for parachutists. This device straps onto the user and alerts the user via audio cues as to the user's altitude, calculated by a LIDAR-like device. This invention also appears to use hardware making the donning and doffing of the device simple for the user, a more modular use of a LIDAR for altimeter purposes.

The purpose of the embodiments described herein is to provide an accurate and reliable device to determine altitude above ground for aircraft.

### SUMMARY OF THE INVENTION

The embodiments of the Modular LIDAR Altimeter for Aircraft are comprised of a LIDAR, a battery pack, a switch, a microcontroller, a wireless transceiver, housing, and attachment mechanism. The battery pack may be comprised of alkaline, lithium ion or other types of battery storage mediums. The power switch allows the user to turn power on or off to the device from the battery pack. The wireless transceiver allows information to be sent and received wirelessly from another device. The LIDAR senses the distance from the ground to the aircraft. The microcontroller controls the components of the modular LIDAR altimeter.

The Modular LIDAR is designed to be attached to the outside of the aircraft to allow the LIDAR unit to have an unimpeded view of the ground for accurate altimeter readings. Mounting the device to the aircraft can be accomplished in several ways. One of these ways would be to strap the unit to the strut brace of a high wing aircraft. The material placed against the strut would have to have a high degree of friction to ensure that the device did not slip on the strut, probably some sort of rubber. The straps could be of any material of sufficient strength to ensure that the device did not become detached during flight, possibly nylon. Buckles of various types and arrangements already exist to ensure that the strap would remain attached to the device.

Mounting of the device could also be accomplished with means other than straps. A simple mechanism could exist that clamps part of the aircraft between two plates, similar to a bench vice. These plates could be shaped to follow the contour of the part to which they are clamping. For instance, clamping onto the wing strut would necessitate that the interior of the two opposing plates be shaped like the strut to allow maximum grip. These plates could be tensioned together via a simple screw system, allowing minimal use of tools for doming or doffing of the Modular LIDAR.

Similarly, these methods could be used to mount the device to alternative points of the aircraft, such as a landing gear, tie-down point etc. The point of these mount methods is to ensure that the LIDAR has an unimpeded view of the ground.

The Modular LIDAR Altimeter for Aircraft uses a LIDAR to determine the aircraft's position above the ground. The wavelength of light used does not matter, provided that it does not violate local regulations and is not readily absorbed by particulate matter in the air so that it can reach the ground and be properly reflected back towards the device. The LIDAR consists of the unit that emits the laser and detects the reflected laser light. The LIDAR is controlled by a microcontroller which determines the rate at which the laser light is emitted, computes the distances, and translates this information for use. The microcontroller feeds this information to a wireless transceiver. This transceiver communicates with a separate device near the pilot, possibly a smart phone. Communication with this pilot device allows the LIDAR data to be given to the pilot, while possibly the pilot can communicate back to the modular LIDAR simple instructions.

It is to be understood that while the LIDAR, microcontroller, and transceiver are labeled as discrete parts here, they may be printed on a single circuit board so as to be indistinguishable from each other.

The housing of the modular LIDAR is the container that contains the electronics for the modular LIDAR, such as the microcontroller, transceiver, LIDAR, batteries, and switch. The housing should be constructed so as to keep the contained electronics weather resistant, most importantly water resistant. The housing of the modular should be constructed so as to be structurally stable vibrationally and aerodynamically as these will be prevalent forces encountered during flight.

### BRIEF DESCRIPTION OF THE DRAWINGS

FIG. 1 is a perspective view of a first exemplary embodiment of the modular LIDAR altimeter for aircraft from the front left side.

FIG. 2 is an exemplary embodiment of the electronic housing from the bottom right side.

FIG. 3 is a block diagram illustrating the connections of the various electronic components.

FIG. 4 illustrates a view of an aircraft equipped with the modular LIDAR altimeter. The cartesian coordinate system displayed with the aircraft is meant to be for reference only.

### DETAILED DESCRIPTION OF THE INVENTION

The invention described herein will be understood by reference to the following detailed description. This description is meant to be aided by and read in conjunction with the related drawings. It is expected that the following detailed description of assorted embodiments is to make an example of only and is not meant to be limiting the scope of the present invention. The inventor anticipates that such variations may include utilizing some or all of the various aspects of the present invention, stating alone, or in combinations other than expressly disclosed herein with respect to the preferred embodiments. Accordingly, this invention includes all modifications and equivalents of the subject matter recited or suggested herein as permitted by applicable law. Moreover, any combination of the above-described elements in all possible variations thereof is encompassed by the invention unless otherwise indicated herein or otherwise clearly contradicted by context.

The terms “a” and “an” and “the” and similar referents in describing the invention are to be interpreted to cover both singular and plural forms, unless otherwise indicated or contraindicated by the context. The terms “having,” “including,” and “containing,” are to be interpreted as open-ended terms (i.e., “including, but not limited to.”) unless otherwise noted. The use of any and all examples, or exemplary language (e.g., “Such as”) provided is intended merely to better illuminate the invention and does not pose a limitation on the scope of the invention unless otherwise claimed. It is also to be understood that the terminology used is used to describe certain embodiments only and is not intended to limit the scope of the invention.

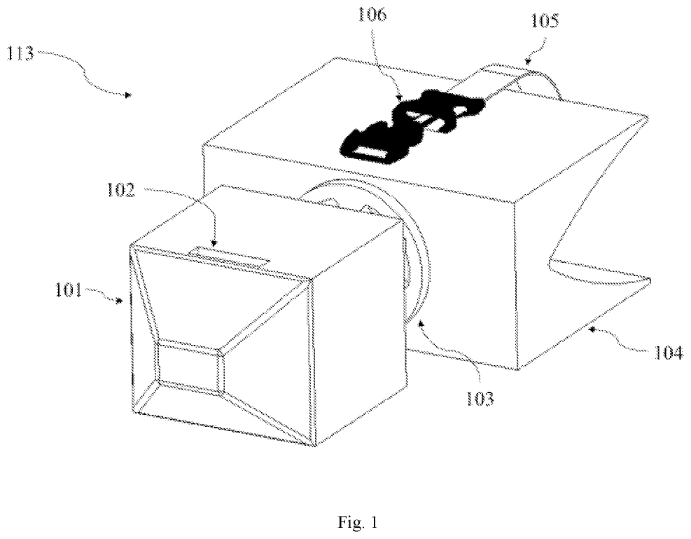

FIG. 1 shows an exemplary embodiment of the modular LIDAR altimeter device 113. This device includes the electronic housing 101, a leveling mechanism 102, a rotational mechanism 103, an aircraft attachment block 104, an aircraft attachment strap 105, and an aircraft attachment clip 106.

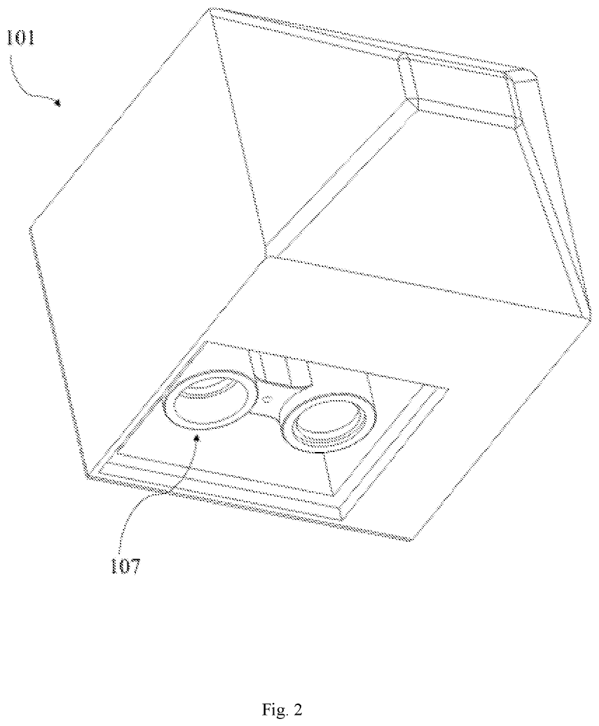

In FIG. 2 it is illustrated that the LIDAR 107 is installed inside the electronic housing 101 in a manner that the LIDAR 107 can emit its laser downward through the bottom of the housing without interference.

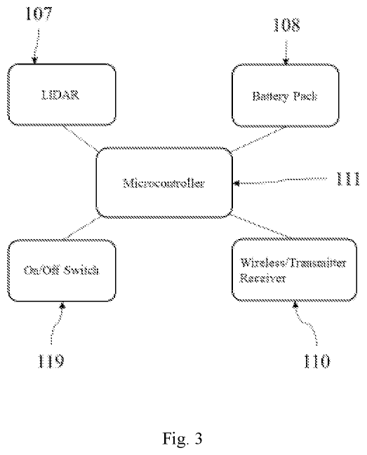

FIG. 3 illustrates the electronic connections necessary for the modular LIDAR altimeter. The LIDAR 107 emits electromagnetic radiation and measures the time of flight for the radiation to return from the reflected object, thereby measuring the distance. The microcontroller 111 controls the timing of the LIDARs 107 pulses, receives signals from the LIDAR 107, and interprets those signals. This information is passed on to the wireless transceiver 110 which sends signals wirelessly to a user device. Signals can also be received by the transceiver 110 so that commands may be given to the microcontroller 111. The electric battery pack 108 provides power to the electronic components. The battery pack 108 may consist of either rechargeable batteries or disposable batteries of varying chemistries. The on/off switch 119 determines whether or not the electronic components receive power from the electric battery 108. The microcontroller 111 is capable of sending and receiving data to both the transceiver 110 and the LIDAR 107. In this capacity, the microcontroller may instruct the LIDAR 107 to power off so as to save battery life. Data transmitted from the transceiver 110 may be read by a purpose-built device designed to interpret the data, a smartphone with an appropriate application, or other such devices.

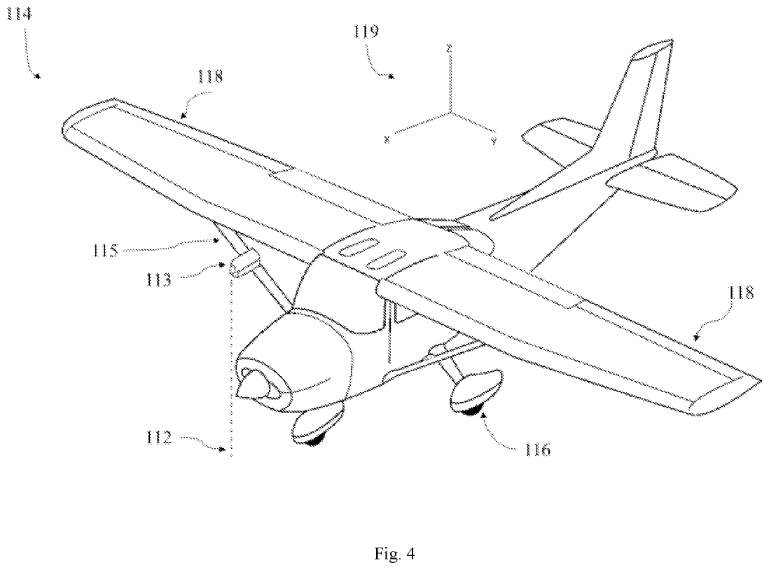

FIG. 4 illustrates the operation of the modular LIDAR altimeter device 113 when attached to the aircraft 114

The rotational mechanism 103 works by allowing the electronic housing 101 to be rotated so as to allow the LIDAR 107 to be directed straight downwards in relation to the aircraft 114. The accuracy of the rotation of the device can be gauged by a level mechanism 102 which will allow the user to determine true level without the use of additional tools. This could be done with the use of a common bubble level. Some iterations of this invention could foreseeably use an electronic gyroscope/accelerometer to more accurately determine true level. The ability to rotate the device and to find true level are important for the modularity of the device, as this allows the user to install and remove the device correctly at will without having to use additional tools.

The rotational mechanism 103 rotates about one axis, in this instance the X-axis visible on the cartesian coordinate system 119 seen in FIG. 4. This is possible when mounting to a surface that is parallel to the direction of travel of the aircraft, such as the aerodynamic profile of a wing strut 115. While the wing strut member is not parallel with the aircraft in other axes, this is not necessary as long as the LIDAR can be assured to point straight downwards in relation to the aircraft. In cases where proper surfaces cannot be found to mount the modular LIDAR altimeter 113 that allow for the rotation of the device about one axis to allow for proper orientation of the LIDAR 107 then the rotation mechanism 103 may be modified to allow for rotation in more than one axis.

The modular LIDAR altimeter in FIG. 1 is shown with an attachment strap 105 and attachment clip 106 to secure the attachment block 104 to the aircraft 114. Multiple straps/clips could be possibly be used to further secure the device. The illustration is meant to be demonstrative, and not limiting the attachment mechanism of the modular LIDAR altimeter 113. One could imagine instead replacing the strap 105 with a screw tensioning device whereby the aircraft wing strut 115 would be sandwiched between two appropriately shaped plates. One could also imagine that instead of these options that there exists a suction cup to secure the device to some suitable portion of the aircraft. Again, these descriptions are meant to be demonstrative and not limiting to the attachment mechanism.

The attachment block 104 shown in FIG. 1 shows a profile to fit the profile of a wing strut 115. This illustration is meant to be demonstrative, and not limiting the attachment block of the modular LIDAR altimeter 113. One could imagine instead that the contour of the attachment block 104 could match the profile of the strut of a landing gear leg 116, or another easily accessible hardpoint on the aircraft, provided that attaching the modular LIDAR altimeter at the location would not prevent proper operation of the aircraft.

The attachment block 104 should be constructed of a material the exhibits a high coefficient of friction with the material that it is being attached to. Typically, aircraft hardware is made of aluminum, so a rubber type material would be a suitable choice for the attachment block 104. This material must also be able to withstand the aerodynamic forces of flight, as well as being resistant to the elements.

The electronic housing 101 should be shaped in an aerodynamic manner so as to allow for the least resistance when the aircraft is in flight. Similarly, the size of the modular LIDAR altimeter 113 should be as small as possible while not degrading the capabilities of the device. The electronic housing 101 should be constructed of a material that is structurally strong, transparent to electromagnetic radiation of the transceiver, water tolerant. With these characteristics in mind, high strength plastics such as nylon, or composites such as fiberglass or carbon fiber would be ideal choices. One skilled in the practice of such arts will realize that there are many alternatives and derivatives to the choices listed here, and this list is not meant to be conclusive.

The LIDAR 107 is shown pointing straight down in relation to the aircraft and emitting laser radiation 112 while operating. In flight, there will be instances where the LIDAR 107 will not be pointed directly perpendicular to the ground. Such instances are small when approaching for a landing, where this information is most useful to a pilot. In normal flight, these instances are larger, and will more proportionately affect the ranging of the LIDAR 107. The microcontroller may contain an electronic gyroscope/accelerometer to measure the aircraft 114 position with respect to its orientation above the ground. These measurements could be used along with the LIDAR 107 range data to triangulate the true altitude of the aircraft above the ground. Additionally, the LIDAR 107 could be mounted on a gimbal to reduce its susceptibility to aircraft maneuvers.

What is claimed is:

1. A device that is capable of measuring altitude above ground level comprising:
a laser measuring instrument, commonly referred to as a LIDAR
a method of rotating the LIDAR to point towards the ground
a method of attaching the device to the aircraft without specialized tools or modifying the aircraft itself
a component to wirelessly transmit and receive data
a microcontroller
a battery pack
a power switch.

2. The device of claim 1 which contains a LIDAR unit which measures the distance from the aircraft to the ground.

3. The device of claim 1 wherein the device is designed to be mounted to the exterior of the aircraft giving the LIDAR an unimpeded view of the ground.

4. The device of claim 3 wherein the device is designed to be mounted with easily releasable hardware to secure the device to the outside of the aircraft.

5. The device of claim 3 wherein the LIDAR can be manipulated to point towards the ground regardless of the angle of installation of the device.

6. The device of claim 1 wherein there exists an onboard microcontroller to function the device.

7. The device of claim 6 wherein there exists a wireless transceiver to transmit and receive data.
